(19) United States
(12) Patent Application Publication
(10) Pub. No.: US 2019/0184390 A1
(43) Pub. Date: Jun. 20, 2019

(54) SOLUTION EJECTING DEVICE AND SOLUTION DROPPING DEVICE

(71) Applicant: TOSHIBA TEC KABUSHIKI KAISHA, Tokyo (JP)

(72) Inventors: Shuhei YOKOYAMA, Mishima Shizuoka (JP); Ryutaro KUSUNOKI, Mishima Shizuoka (JP)

(21) Appl. No.: 16/221,266

(22) Filed: Dec. 14, 2018

(30) Foreign Application Priority Data
Dec. 20, 2017 (JP) 2017-243960

(51) Int. Cl. B01L 3/02; G01N 35/10

(52) U.S. Cl. CPC B01L 3/0268; G01N 35/10; G01N 2035/1041; B01L 2200/0605; B01L 2300/16; B01L 2300/0829

(57) ABSTRACT

An embodiment comprises a drug solution ejecting device having a pressure chamber including a discharge port on a first side, a supply port on a second side, and an inner wall of the pressure chamber between the first and second sides. An actuator is configured to change pressure to eject a solution from a nozzle via the discharge port. The inner wall of the pressure chamber includes at least a part that is silicon or silicon oxide. As detected by X-rat photoelectron spectroscopy, a surface of the part has a ratio of a total area of peaks of silicon in monovalent, divalent, and trivalent binding states to an area of a peak of silicon in a tetravalent binding state that is greater than a same such ratio of a surface of a silicon wafer having only an untreated natural oxide film formed thereon.

### CROSS-REFERENCE TO RELATED APPLICATION

This application is based upon and claims the benefit of priority from. Japanese Patent Application No. 2017-243960, filed Dec. 20, 2017, the entire contents of which are incorporated herein by reference.

### FIELD

Embodiments described herein relate to a solution ejecting device and a solution dropping device.

### BACKGROUND

In the fields of biology, pharmacy, medical diagnoses and examinations, and agricultural testing, the dispensing of a fluid in picoliter (pL) to microliter (μL) volumes is sometimes performed. As one possible device for such a purpose, a droplet jet device is known.

When the fluid to be dispensed is a drug solution, the droplet jet device is sometimes called “drug solution dropping device” or a “drug solution droplet dispenser.” As the drug solution dropping device, there is a device in which a drug solution ejecting device, which is filled with a drug solution, is detachably mounted. In such a drug solution dropping device, the drug solution ejecting device is discarded after the drug solution has been ejected. The single-use drug solution ejection device is for preventing contamination.

As for the types of the solutions that can be ejected by the drug solution ejecting device, there are two broad types: an aqueous solution and an organic solvent solution. The aqueous solution is, for example, solute dissolved in water, phosphate-buffered saline (water content is 99 mass % or more), or an aqueous glycerin solution (glycerin content is 60 mass % or less and a water content is 40 mass % or more). A solvent for the organic solvent solution is, for example, dimethyl sulfoxide (DMSO).

### DESCRIPTION OF THE DRAWING

FIG. 1 is a perspective view depicting a drug solution dropping device including a drug solution ejecting device according to an embodiment.

FIG. 2 is a top view showing a drug solution ejecting device according to an embodiment.

FIG. 3 is a bottom view showing a drug solution ejecting device according to an embodiment.

FIG. 4 is a cross-sectional view taken along line F4-F4 of FIG. 2.

FIG. 5 is a top view depicting a drug solution ejecting array of an drug solution ejecting device according to an embodiment.

FIG. 6 is a cross-sectional view taken along line F6-F6 of FIG. 5.

FIG. 7 is a cross-sectional view taken along line F7-F7 of FIG. 5.

FIG. 8 is a graph depicting changes in a contact angle of pure water on a silicon oxide film for different oxygen plasma ashing times.

FIG. 9 is a graph depicting a Si2p spectrum obtained by performing XPS measurement of a silicon wafer having a silicon oxide film.

FIG. 10 is a graph depicting a Si2p spectrum obtained by performing XPS measurement after oxygen plasma ashing of a silicon wafer having a silicon oxide film.

FIG. 11 is a schematic cross-sectional view of a second face of a silicon wafer having a silicon oxide film.

FIG. 12 is a schematic cross-sectional view of an inner wall of a pressure chamber.

FIG. 13 is a graph depicting a Si2p spectrum obtained by performing XPS measurement of a silicon wafer having a natural oxide film.

FIG. 14 is a graph depicting a Si2p spectrum obtained by performing XPS measurement after oxygen plasma ashing of a silicon wafer having a natural oxide film.

### DETAILED DESCRIPTION

According to one aspect, a drug solution ejecting device comprises a pressure chamber including a discharge port on a first side, a supply port on a second side, and an inner wall between the first and second sides. An actuator is configured to change pressure in the pressure chamber to eject a solution in the pressure chamber from a nozzle via the discharge port. The inner wall of the pressure chamber includes at least a part that is silicon or silicon oxide. A surface of the part has a ratio of a total area of peaks of silicon in monovalent, divalent, and trivalent binding states, as detected by X-ray photoelectron spectroscopy, to an area of a peak of silicon in a tetravalent binding state, as detected by X-ray photoelectron spectroscopy, that is greater than such a ratio of a surface of a silicon wafer having only an untreated, natural oxide film formed thereon. In this context, “untreated, natural oxide film formed thereon” means the natural (also referred to as native) oxide film which unavoidably forms on a silicon surface that is exposed to a normal atmospheric environment is not substantially exposed to an oxygen plasma processing, an ultraviolet irradiation process at 300 nm wavelength or less, or other processing that would be expected to alter the natural oxide film.

Hereinafter, embodiments will be described with reference to the drawings. The drawings are schematic views for explaining example embodiments and facilitating the understanding thereof and include some portions whose shapes, dimensions, ratios, etc. are different from those of actual ones, but design changes thereof may be appropriately performed.

<Structure>

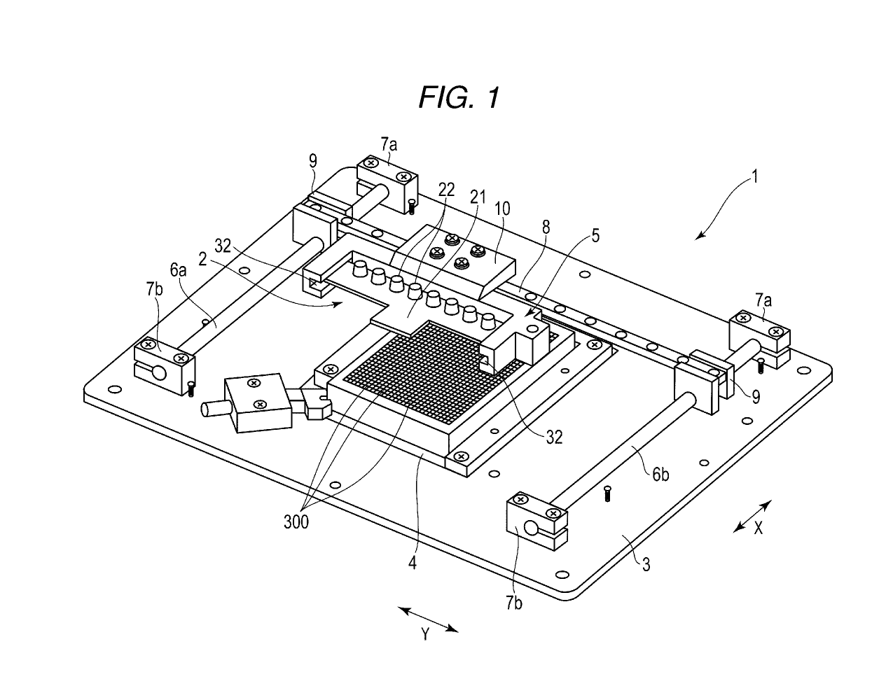

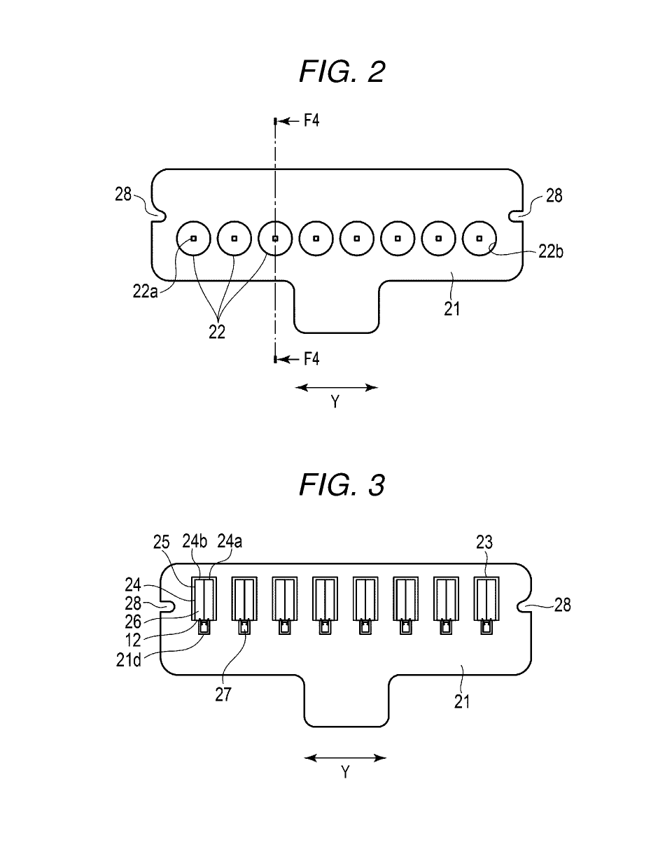

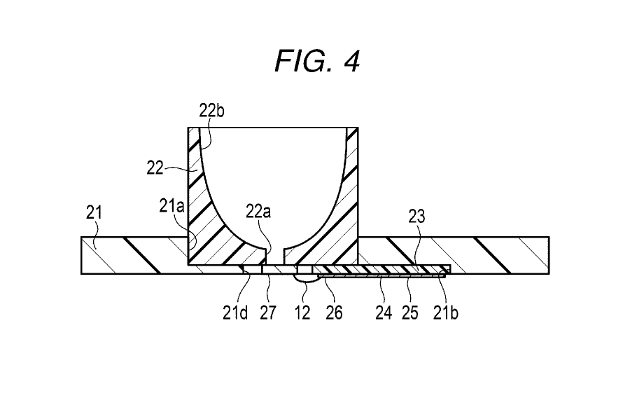

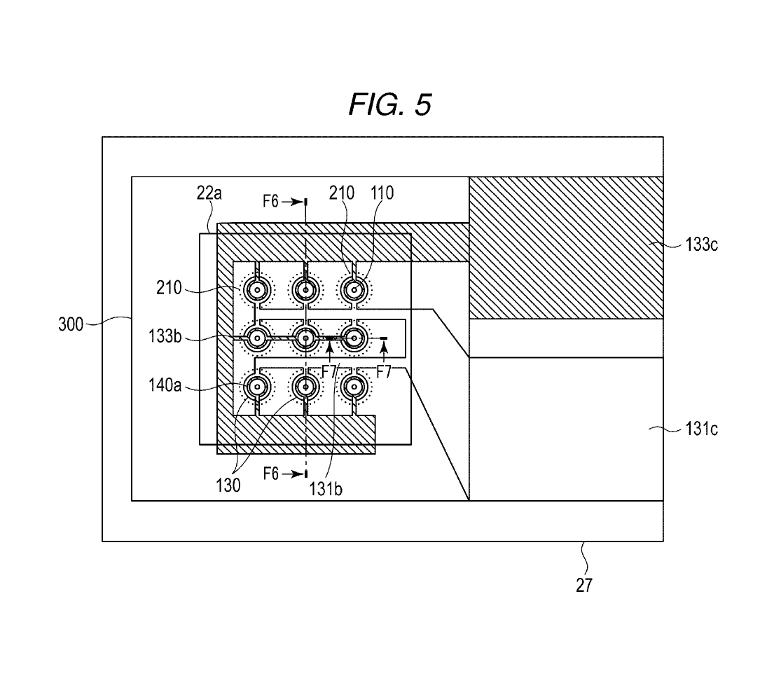

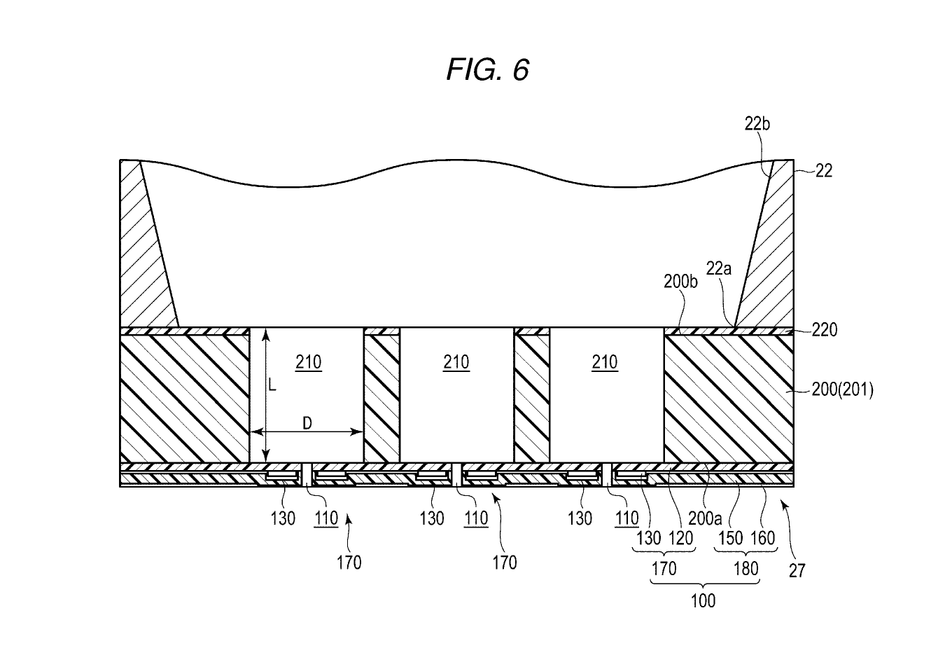

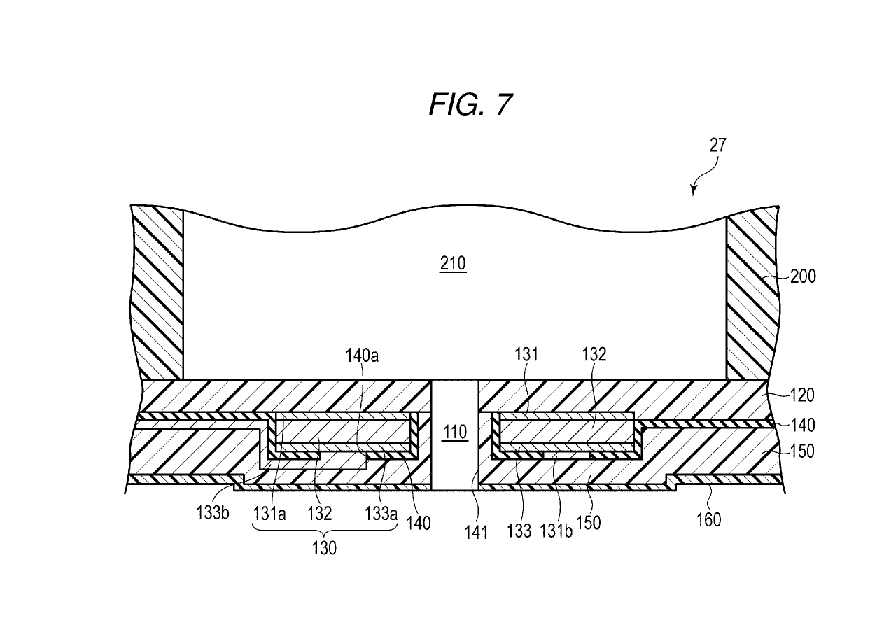

An example of a drug solution ejecting device of an embodiment will be described with reference to FIGS. 1 to 7. FIG. 1 is a perspective view showing a schematic overall structure of a drug solution dropping device including a drug solution ejecting device according to an embodiment. FIG. 2 is a view showing an upper face of the drug solution ejecting device. FIG. 3 is a view showing a lower face, which is the face from which the drug solution ejecting device ejects a droplet. FIG. 4 is a cross-sectional view taken along line F4-F4 of FIG. 2. FIG. 5 is a view showing an upper face of a drug solution ejecting array of the drug solution ejecting device. FIG. 6 is a cross-sectional view taken along line F6-F6 of FIG. 5. FIG. 7 is a cross-sectional view taken along line F7-F7 of FIG. 5.

The drug solution dropping device 1 shown in FIG. 1 includes a base table 3 in a rectangular flat plate shape, a drug solution ejecting device 2, and a mounting portion 5 on which the drug solution ejecting device 2 is mounted. In this embodiment, the drug solution is dropped to a microplate 4 is described as one possible example. Here, the front to rear direction of the base table 3 is called “X direction” and the left to right direction of the base table 3 is called “Y direction”. The X direction and the Y direction are orthogonal to each other.

The microplate 4 has a total of 1536 wells 300. The microplate 4 is detachably fixed to the base table 3. The drug solution dropping device 1 includes a pair of X-direction guide rails 6a and 6b extending in the X direction on both sides of the microplate 4 on the base table 3. The end portions of the X-direction guide rails 6a and 6b are fixed to fixing mounts 7a and 7b projecting from the base table 3.

Between the X-direction guide rails 6a and 6b, a Y-direction guide rail 8 is provided extending in the Y direction. Both ends of the Y-direction guide rail 8 are each fixed to an X-direction moving mount 9 that is slidable in the X direction along the X-direction guide rails 6a and 6b.

The Y-direction guide rail 8 is provided with a Y-direction moving mount 10 that is movable in the Y direction along the Y-direction guide rail 8. To this Y-direction moving mount 10, the mounting portion 5 is attached. In this mounting portion 5, a slit 32 is formed, and the drug solution ejecting device 2 is detachably fixed at this position. By a combination of an act of the Y-direction moving mount 10 moving in the Y direction along the Y-direction guide rail 8 with an act of the X-direction moving mount 9 moving in the X direction along the X-direction guide rails 6a and 6b, the drug solution ejecting device 2 can move to an arbitrary position the X-Y plane direction.

In this example, the drug solution ejecting device is discarded after a single use.

The drug solution ejecting device includes a pressure chamber structure which includes a first face and a second face, and is provided with a pressure chamber therein. The pressure chamber includes a supply port through which a drug solution is supplied from the second face side and a discharge port through which the drug solution is discharged from the first face side. At least a part of an inner wall of the pressure chamber is comprised of silicon or silicon oxide. A surface of the part composed of silicon or silicon oxide has a ratio of the total area of peaks of silicon in monovalent, divalent, and trivalent binding states detected by X-ray photoelectron spectroscopy to the area of a peak of silicon in a tetravalent binding state detected by X-ray photoelectron spectroscopy this larger as compared with a surface of a silicon wafer having a natural oxide film formed thereon, and which has not been irradiated with ultraviolet light or treated with oxygen plasma. An actuator is provided in the drug solution ejecting device to change the pressure in the pressure chamber to eject the drug solution from a nozzle.

The drug solution ejecting device 2 includes a base member 21 having a flat plate shape. As shown in FIGS. 1 and 2, a plurality of drug solution holding vessels 22 are arranged side by side in a line in the Y direction on an upper surface of the base member 21. In this example, eight (8) drug solution holding vessels 22 are provided; however, the number of drug solution holding vessels 22 is not limited to this number.

As shown in FIG. 2, at both ends of the base member 21, a notch 28, for mounting and fixing the base member to the mounting portion 5, is formed. These two notches 28 are each formed in a semi-elongated circular notch shape. These notches 28 may also be referred to as engagement recesses. Each notch 28 may be semi-circular, semi-elliptical, or triangular shape, or the like. In this example, the two notches 28 have a different shape from each other. According to this, the left and right notch shapes on the base member 21 are different, and confirmation of the posture of the base member 21 can be easily performed.

On the base member 21, as shown in FIG. 4, a recessed portion 21a in a cylindrical shape is formed for each drug solution holding vessel 22. The drug solution holding vessels 22 have a corresponding cylindrical shape to match the recessed portion 21a.

The bottom of the drug solution holding vessel 22 is adhered and fixed to the recessed portion 21a. Further, as shown in FIGS. 2 and 4, the drug solution holding vessel 22 includes an opening 22a serving as a drug solution outlet at a central position of the bottom thereof. An upper face opening 22b of the drug solution holding vessel 22 has a larger opening area than the opening 22a of the drug solution outlet.

As shown in FIG. 3, the base member 21 includes electrical substrates 23 in equal number to the number of drug solution holding vessels 22. The electrical substrates 23 are arranged in a line in the Y direction on the rear face side of the base member 21. The rear face of the base member 21 is the lower face of the base member 21 when the drug solution ejecting device 2 is properly inserted in the drug solution dropping device 1. The electrical substrate 23 is a flat rectangular plate member.

As shown in FIG. 4, the base member 21 includes an electrical substrate recessed portion 21b for accommodating the electrical substrate 23. The base member 21 also includes a drug solution ejecting array portion opening 21d, which connects with the electrical substrate recessed portion 21b on the rear face side thereof. A proximal end portion of the electrical substrate recessed portion 21b extends up to a position near an upper end portion (a position near a right end portion in FIG. 4) of the base member 21 shown in FIG. 3. Further, as shown in FIG. 4, a distal end portion of the electrical substrate recessed portion 21b extends up to a position overlapped with a part of the drug solution holding vessel 22.

The electrical substrate 23 is adhered and fixed to the electrical substrate recessed portion 21b. The electrical substrate 23 includes an electrical substrate wiring 24 on a face opposite the face adhered and fixed to the electrical substrate recessed portion 21b as shown in FIGS. 3 and 4.

The electrical substrate wiring 24 includes a control signal input terminal 25 for receiving a control signal from the outside on one end portion thereof. The electrical substrate wiring 24 includes an electrode terminal connection portion 26 on the other end portion thereof.

Further, as shown in FIG. 3, the electrical substrate wiring 24 comprises wiring patterns 24a and 24b. The electrode terminal connection portion 26 is connected to a terminal portion 131c and a terminal portion 133c formed on a drug solution ejecting array 27 shown in FIG. 5 through a wiring line 12. The wiring patterns 24a and 24b are thus electrically connected to the lower electrode terminal portion 131c and the upper electrode terminal portion 133c, respectively.

As shown in FIG. 4, the base member 21 is provided with a through-hole for the drug solution ejecting array portion opening 21d. As shown in FIG. 3, the drug solution ejecting array portion opening 21d is an opening in a rectangular shape. Further, as shown in FIG. 4, the drug solution ejecting array portion opening 21d is formed on the rear face side of the base member 21 at a position overlapping with the recessed portion 21a.

The drug solution ejecting array 27, shown in FIGS. 3 to 5, is adhered and fixed to a lower face of the drug solution holding vessel 22, while the opening 22a of the drug solution holding vessel 22 is covered. This drug solution ejecting array 27 is placed at a position corresponding to the drug solution ejecting array portion opening 21d as shown in FIGS. 3 and 4.

A structure of the drug solution ejecting array 27 will be further described with reference to FIGS. 5 to 7. FIG. 6 is a cross-sectional view taken along line F6-F6 of FIG. 5. FIG. 7 is a cross-sectional view taken along line F7-F7 of FIG. 5.

As shown in FIG. 6, the drug solution ejecting array 27 is formed by stacking a nozzle plate 100 and a pressure chamber structure 200.

The pressure chamber structure 200 has a first face 200a and a second face 200b. On the first face 200a, a vibration plate 120 is provided, and on the second face 200b, a warp reduction film 220 serving is provided. The pressure chamber structure 200 internally includes a pressure chamber 210, which penetrates through the warp reduction film 220, to reach the vibration plate 120. The pressure chamber 210 communicates with the nozzle 110.

The pressure chamber 210 includes a supply port, which communicates with the opening 22a of the drug solution holding vessel 22, and through which a drug solution is supplied, and a discharge port through which the drug solution is discharged. The pressure chamber 210 is, for example, formed in a cylindrical shape located coaxially with the nozzle 110.

The pressure chamber 210 preferably has a dimension such that a length L in the depth direction is large as compared to a length D in the width direction of the supply port. A configuration in which the pressure chamber 210 has such a dimension is advantageous in delaying the release of pressure applied to the drug solution in the pressure chamber 210 by vibration of the vibration plate 120 to the drug solution holding vessel 22.

A side wall surrounding the pressure chamber 210 is vertical from the first face 200a to the second face 200b, according to one example. In other examples, the pressure chamber 210 has a structure tapered toward the first face 200a from the second face 200b. A configuration in which the pressure chamber 210 has such a tapered shape is advantageous in obtaining a drug solution ejecting device with improved ejection of the drug solution.

A material of at least apart of an inner wall of the pressure chamber 210 is silicon or silicon oxide. A surface of the part composed of silicon or silicon oxide of the inner wall of the pressure chamber 210 has a ratio of the total area of peaks of silicon in monovalent, divalent, and trivalent binding states detected by X-ray photoelectron spectroscopy (hereinafter referred to as “XPS analysis”) to the area of a peak of silicon in a tetravalent binding state detected by XPS analysis that is larger than such a ratio for a surface of a silicon wafer having a natural oxide film formed thereon, and which has not been irradiated with ultraviolet light or treated with oxygen plasma. In this example, the peak area ratio is preferably at least 0.25 or more.

When this peak area ratio is too small, there is a fear that aqueous solutions will be poorly ejected.

Here, the peaks of “silicon in monovalent, divalent, and trivalent binding states” are peaks derived from silicon having a dangling bond. The peaks of “silicon in monovalent, divalent, and trivalent binding states” are peaks derived from intermediate products, that is, sub-oxides in the process of oxidation of silicon present at an interface between a SiO₂ film and a silicon bulk region.

The binding states of silicon in sub-oxides are different from a binding state of silicon in a silicon oxide film (hereinafter also referred to as “tetravalent silicon” or “Si₄₊”) and that of bulk silicon (hereinafter also referred to as “zerovalent silicon” or “Si₀ (zero)”) of a silicon wafer binding only to a silicon atom.

Silicon in monovalent, divalent, and trivalent binding states means that there exist substances represented by the compositional formulae: Si_{0.5}O (or Si₂O), SiO, and Si_{1.5}O (or Si₂O₃), respectively. In this context, Si_{0.5}O, SiO, and Si_{1.5}O are referred to as “monovalent silicon”, “divalent silicon”, and “trivalent silicon”, respectively, and represented by Si₁₊, Si₂₊, and Si₃₊, respectively.

The surface of the part composed of silicon or silicon oxide of the inner wall of the pressure chamber 210 has a pressure chamber inner film 202 (see FIG. 12) composed of a natural oxide film, such as that has been formed on the surface of a silicon wafer 201, which is used to form pressure chamber structure 200.

The pressure chamber inner film 202 has a film thickness of, for example, 3 nm or less. The drug solution ejecting device 2 according to this embodiment can achieve high wettability even with respect to an aqueous solution because the pressure chamber inner film 202 contains many silicon atoms having a dangling bond. Incidentally, silicon in a monovalent, divalent, or trivalent binding state may exist, and the relative abundance ratio of these states is not particularly limited.

The warp reduction film 220 is a silicon oxide film having a thickness of 4 μm formed on the surface of the silicon wafer 201 by, for example, heating the silicon wafer 201 in an oxygen atmosphere. The warp reduction film 220 reduces warpage occurring in the drug solution ejecting array 27. In some examples, the warp reduction film 220 may be a silicon oxide film deposited on the surface of the silicon wafer 201 by a chemical vapor deposition (CVD) method. However, when the silicon oxide film is formed by thermal oxidation, improved uniformity can be imparted to the warp reduction film 220 as compared with the case where the silicon oxide film is formed by a CVD method.

The material, the film thickness, and the like of the warp reduction film 220 may be different from those of the vibration plate 120. However, when the material and the film thickness of the warp reduction film 220 are made the same as those of the vibration plate 120, a difference in film stress between the silicon wafer 201 and the vibration plate 120 and a difference in film stress between the silicon wafer 201 and the warp reduction film 220 are comparable to each other. Therefore, when the material and the film thickness of the warp reduction film 220 and the material and the film thickness of the vibration plate 120 are the same, a warp occurring in the drug solution ejecting array 27 is typically reduced.

The nozzle plate 100 includes an actuator 170 and a nozzle member 180 (see FIG. 6).

Here, the term “nozzle member” means a member in which the nozzle 110 is formed. In this example, the actuator 170 is formed integrally with the nozzle member 180; however, the actuator 170 may also be formed separately from the nozzle member 180. A configuration in which the nozzle member 180 and the actuator 170 are integrally formed is typically advantageous in performing the oxygen plasma asking for the entire inner face of the drug solution ejecting device in a short time, as described further below.

The actuator 170 is constituted by the vibration plate 120 and a drive element 130 serving as a drive unit.

The vibration plate 120 is a SiO₂ film formed on the surface of the silicon wafer 201 by heating the silicon wafer 201 in an oxygen atmosphere. Therefore, the vibration plate 120 is integrated with the pressure chamber structure 200 eventually formed from the silicon wafer 201. However, the vibration plate 120 may also be separate from the pressure chamber structure 200 in other examples.

The film thickness of the vibration plate 120 is preferably within a range of 1 to 30 μm. In some examples, the vibration plate 120 may be formed by depositing a silicon oxide film on the surface of the silicon wafer 201 by a chemical vapor deposition (CVD) method. However, when the silicon oxide film is formed by thermal oxidation, improved uniformity can be imparted to the vibration plate 120 as compared with the case where the silicon oxide film is formed by a CVD method.

As shown in FIG. 6, a drive element 130 is formed for each nozzle 110. Further, as shown in FIG. 5, each drive element 130 has an annular shape surrounding the nozzle 110. The shape of the drive element 130 is not particularly limited, and may be, for example, a C-shape obtained by cutting a part of an annular shape.

The drive element 130 shown in FIG. 7 includes an electrode portion 131a, which is a part of a lower electrode 131, an electrode portion 133a, which is a part of an upper electrode 133, and a piezoelectric film 132. The piezoelectric film 132 is located between the electrode portion 131a and the electrode portion 133a.

The lower electrode 131 includes a plurality of electrode portions 131a in an annular shape and coaxial with the plurality of nozzles 110 in a circular shape. In FIG. 5, the drive element 130 is shown in a state where the electrode portion 131a and the electrode portion 133a are overlapped with each other. The lower electrode 131 includes a wiring portion 131b connecting the electrode portions 131a and includes the terminal portion 131c in an end portion of the wiring portion 131b.

The upper electrode 133 includes electrode portions 133a having an annular shape and coaxial with the nozzles 110. The upper electrode 133 has the same shape as that of the piezoelectric film 132. As shown in FIG. 5, the upper electrode 133 includes a wiring portion 133b connecting the electrode portions 133a and includes the terminal portion 133c in an end portion of the wiring portion 133b.

The lower electrode 131 and the upper electrode 133 are electrically connected to the electrode terminal connection portion 26 of the electrical substrate 23. That is, one face of the drive element 130 is electrically connected to the wiring pattern 24a. The other face of the drive element 130 is electrically connected to the wiring pattern 24b. A differential voltage is applied to the drive element 130 according to a voltage applied to the wiring pattern 24a and a voltage applied to the wiring pattern 24b. The drive element 130 is driven by the differential voltage.

The drive element 130 includes the piezoelectric film 132 composed of a piezoelectric material. As the piezoelectric material, for example, PZT (Pb(Zr,Ti)O₃: lead titanate zirconate) can be used. Further, as the piezoelectric material, for example, PTO (PbTiO₃: lead titanate), PMNT (Pb(Mg_{1/3}Nb_{2/3})O₃—PbTiO₃), PZNT (Pb(Zn_{1/3}Nb_{2/3})O₃—PbTiO₃), KNN (a compound of KNbO₃ and NaNbO₃), ZnO, AlN, or the like can also be used.

The piezoelectric film 132 generates polarization in the thickness direction. When an electric field in the same direction as the polarization is applied to the piezoelectric film 132, the piezoelectric film 132 expands and contracts in a direction orthogonal to the direction of the electric field. That is, the drive element 130 contracts or expands in a direction orthogonal to the film thickness.

The nozzle member 180 includes a protective film 150, a fluid repellent film 160, and an insulating film 140. Further, the nozzle member 180 has a plurality of nozzles 110 formed therein. Each nozzle 110 communicates with a pressure chamber 210 through the discharge port thereof and ejects a drug solution.

The fluid repellent film 160 is provided so as to cover the protective film 150. The fluid repellent film 160 is formed by, for example, spin coating a silicone resin having a property of repelling the drug solution. The fluid repellent film 160 can also be formed from a material such as a fluorine-containing resin.

The insulating film 140 electrically insulates the lower electrode 131 from the upper electrode 133. The insulating film 140 covers the side face of the drive element 130 and the wiring portion 131b. The insulating film 140 includes a contact portion 140a enabling electrical connection between the electrode portion 133a of the upper electrode 133 and the wiring portion 133b.

The nozzles 110 are arranged in, for example, a 3×3 array. The plurality of nozzles 110 of this embodiment are located inside the opening 22a of the drug solution outlet of the drug solution holding vessel 22.

A material of at least a part of the inner wall of the nozzle 110 and at least apart of the second face 200b is silicon or silicon oxide, and the silicon in the part composed of silicon or silicon oxide of the inner wall face of the nozzle 110 and the second face 200b preferably contains silicon in monovalent, divalent, and trivalent binding states.

The ratio of the total area of peaks of silicon in monovalent, divalent, and trivalent binding states detected by XPS analysis to the area of the peak of silicon in a tetravalent binding state detected by XPS analysis on the part of the inner wall face of the nozzle 110 and the second face 200b is preferably 0.02 or more. A configuration in which this peak area ratio falls within such a range is generally more advantageous for ejecting an aqueous solution.

The pressure chamber structure 200 includes the drug solution holding vessel 22 on the second face 200b side, that is, on the warp reduction film 220 side. The drug solution holding vessel 22 is adhered and fixed to the pressure chamber structure 200 by, for example, an epoxy adhesive.

The pressure chamber 210 communicates with the opening 22a of the drug solution holding vessel 22 through the supply port. The opening area of the opening 22a s preferably larger than the area of the region in which all the supply ports are formed. A configuration in which the area of the opening 22a and the area of region in which all the supply ports for the pressure chambers 210 have such a relationship is advantageous in allowing all the pressure chambers 210 formed in the drug solution ejecting array 27 to communicate with the opening 22a of the drug solution holding vessel 22.

<Production Method>

The drug solution ejecting device 2 can be produced by, for example, the following method.

First, the drug solution holding vessel 22 and the drug solution ejecting array 27 are adhered to each other. Thereafter, oxygen plasma ashing is performed from the upper face opening 22b side of the drug solution holding vessel 22. The oxygen plasma ashing is performed under conditions of, for example, 200 W, 62 Pa, and an oxygen gas flow rate of 100 cc/min for 5 minutes.

After performing such oxygen plasma ashing, the part composed of silicon or silicon oxide of the inner wall of the pressure chamber 210 satisfies the following conditions: the surface of this part has a ratio of the total area of peaks of silicon in monovalent, divalent, and trivalent binding states to the area of a peak of silicon in a tetravalent binding state that is larger than a surface of a silicon wafer having a natural oxide film formed thereon, and which has not been irradiated with ultraviolet light or treated with oxygen plasma.

In the above examples, the drive element 130 has an annular shape; however, the shape of the drive unit is not limited thereto. The shape of the drive unit may be, for example, a diamond, a rhombus, an ellipse, or the like. Further, the planar shape of the pressure chamber 210 is also not limited to a circle, and may be rectangular, rhombic, or an elliptical.

Further, in the above examples, the nozzle 110 is placed at the center of the drive element 130; however, the position of the nozzle 110 is not particularly limited so long as a drug solution can be ejected from the pressure chamber 210. For example, in some examples, the nozzle 110 is not formed in the region surrounded by the drive element 130, but may be formed outside the drive element 130.

<Act>

The drug solution ejecting device 2 of this embodiment is fixed to the mounting portion 5 of the drug solution dispensing device land used. In attaching this drug solution ejecting device 2 to the mounting portion 5, the device 2 is inserted into a slit 32 from the front face opening side of the slit 32.

When the drug solution ejecting device 2 is used a predetermined amount of a drug solution is first supplied to the drug solution holding vessel 22 by a pipetter (not shown) or the like, from the upper face opening 22b of the drug solution holding vessel 22. The drug solution is stored inside the drug solution holding vessel 22. The opening 22a in the bottom of the drug solution holding vessel 22 communicates with the drug solution ejecting array 27. The drug solution in the drug solution holding vessel 22 fills into pressure chambers 210 in the drug solution ejecting array 27 through the opening 22a of the drug solution holding vessel 22.

The drug solution held in the drug solution ejecting device 2 is typically an aqueous solution. The drug solution may contain, for example, a low molecular weight compound, a fluorescent reagent, a protein, an antibody, a nucleic acid, plasma, a bacterium, a hemocyte, and/or a cell. A primary solvent (a substance having a highest weight ratio or a highest volume ratio) of the drug solution is generally water, glycerin, or dimethyl sulfoxide. Here, the term “aqueous solution” means a solution in which the content of water in the solution is 50 mass % or more.

A voltage control signal is input to the control signal input terminal 25. The voltage control signal is applied to the drive element 130 from the electrode terminal connection portion 26 of the electrical substrate wiring 24. The vibration plate 120 is deformed in the thickness direction in response to the application of the signal by voltage control for the drive element 130. According to this, the volume of the pressure chamber 210 is changed so that the pressure on the drug solution in the pressure chamber 210 is changed. As a result, the drug solution is ejected as a drug solution droplet from the nozzle 110 of the drug solution ejecting array 27. By this process, a predetermined amount of the solution is dropped into each well 300 of the microplate 4 from the nozzle 110.

The fluid amount of a droplet ejected from the nozzle 110 is from about 2 to 5 pL. Therefore, by controlling the dispensing frequency, a volume on the order of pL to μL can be dispensed into each well 300 of the microplate 4 in a controlled manner.

<Effect>

A drug solution ejecting device 2 of an embodiment includes a pressure chamber structure 200 having the following characteristics.

The surface of the part of the inner wall of the pressure chamber 210 composed of silicon or silicon oxide has a ratio of the total area of the peaks of silicon in monovalent, divalent, and trivalent binding states, as detected by X-ray photoelectron spectroscopy, to the area of the peak of silicon in a tetravalent binding state, as detected by X-ray photoelectron spectroscopy, that is larger than the surface of a silicon wafer having a natural oxide film formed thereon, and which has not been irradiated with ultraviolet light or treated with oxygen plasma. With such a structure, the drug solution ejecting device 2 can eject a drug solution efficiently even if the drug solution being dispensed is an aqueous solution.

On the other hand, a drug solution ejecting device 2 that has not been subjected to oxygen plasma asking from the upper face opening 22b side of the drug solution holding vessel 22 after the drug solution holding vessel 22 and the pressure chamber structure 200 have been adhered to each other does not eject an aqueous solution efficiently from the drug solution holding vessel 22.

The reason for this will be described below.

First, the effect of performing oxygen plasma ashing will be described.

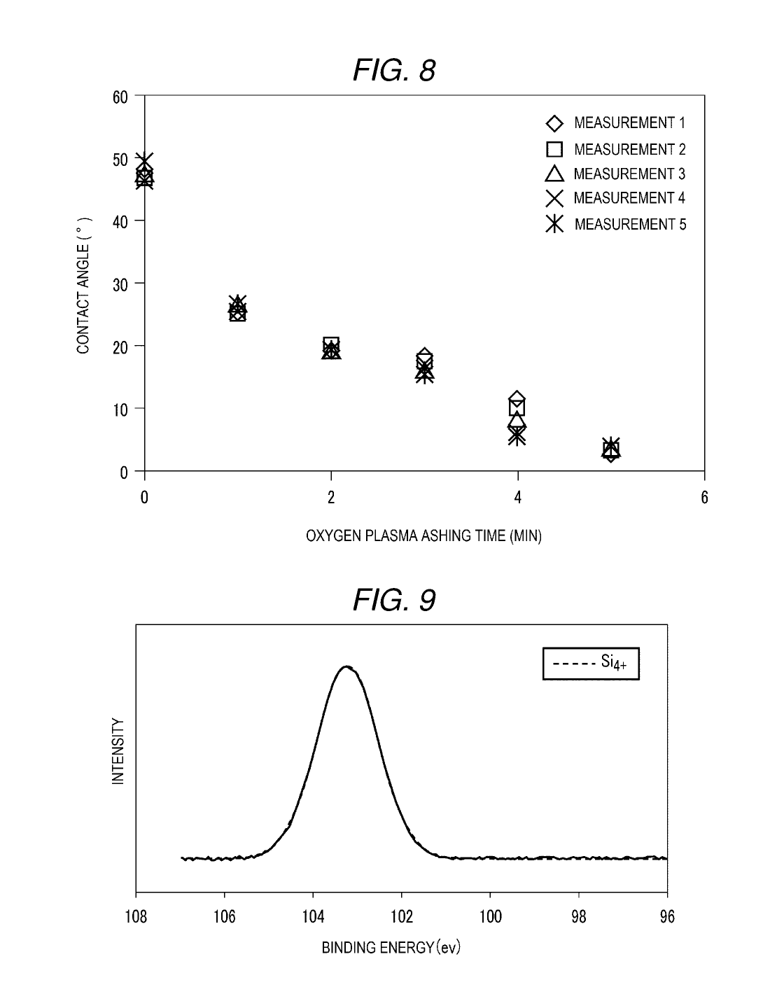

The surface of a silicon wafer having a silicon oxide film was subjected to oxygen plasma ashing. Then, a contact angle of water on the surface of the silicon oxide film was measured. A relationship between the oxygen plasma ashing time and the contact angle of pure water on the silicon oxide film is shown in FIG. 8.

The graph in FIG. 8 is obtained as follows. The surface of a silicon wafer is thermally oxidized to form a silicon oxide film having a film thickness of 4 μm. Subsequently, the surface of this silicon wafer is subjected to oxygen plasma ashing (200 W, 62 Pa, oxygen gas flow rate: 100 cc/min) for 0 min, 1 min, 2 min, 3 min, 4 min, or 5 min. Thereafter, a contact angle of pure water on the silicon oxide film is measured. As a measurement device, a device (PCA-1) manufactured by Kyowa Interface Science Co., Ltd. is used, and a contact angle at 5 seconds after dropping water is measured by a θ/2 method. The measurement of the contact angle is performed at five sites for each time condition. The measurement results are shown in FIG. 8 and Table 1. In FIG. 8 and Table 1, the measurement results at the five different sites labelled: Measurement 1, Measurement 2, Measurement 3, Measurement 4, and Measurement 5.

TABLE 1

| Oxygen | | | | | |
|---|---|---|---|---|---|
| plasma | Contact angle (°) | | | | |
| ashing | Measure- | Measure- | Measure- | Measure- | Measure- |
| time (min) | ment 1 | ment 2 | ment 3 | ment 4 | ment 5 |
| 0 | 48 | 46.6 | 47.3 | 46.4 | 49.2 |
| 1 | 25.2 | 25.1 | 26.6 | 25.5 | 26.5 |
| 2 | 19.4 | 20.1 | 19.1 | 19.1 | 19.3 |
| 3 | 18.1 | 17.6 | 16 | 16.5 | 15.3 |
| 4 | 11.5 | 10.1 | 8.2 | 6.2 | 5.4 |
| 5 | 2.8 | 3.4 | 3.8 | 3.8 | 3.8 |

As shown in FIG. 8 and Table 1, the contact angle of water decreased with the increase in the oxygen plasma ashing time. That is, the wettability of the surface by an aqueous solution was improved as the oxygen plasma ashing time increased.

An ejection test for an aqueous solution was performed as follows. After the drug solution ejecting device 2 was assembled, oxygen plasma ashing was performed from the upper face opening 22b side of the drug solution holding vessel 22 under the same conditions as those for the oxygen plasma ashing performed when obtaining the data of FIG. 8. Then, the relationship between oxygen plasma ashing time and whether or not the aqueous solution was ejected from the drug solution ejecting device 2 was examined. Note, the measurement results shown in FIG. 8 were performed on a silicon wafer. However, the measurement performed and reported in this context here is for an actual assembly. Although there is a structural difference in this manner, the effect of oxygen plasma on the silicon oxide film is considered to be the same for these purposes.

The results of the ejection test were as follows. When the oxygen plasma ashing time was 0 min, the drug solution ejecting device 2 could not eject the aqueous solution. Further, when the oxygen plasma ashing time was 3 min or more, the drug solution ejecting device 2 could eject the aqueous solution.

A binding state of silicon and oxygen contained in each of the silicon oxide films subjected to oxygen plasma ashing for 0 min or 5 min was examined by XPS analysis.

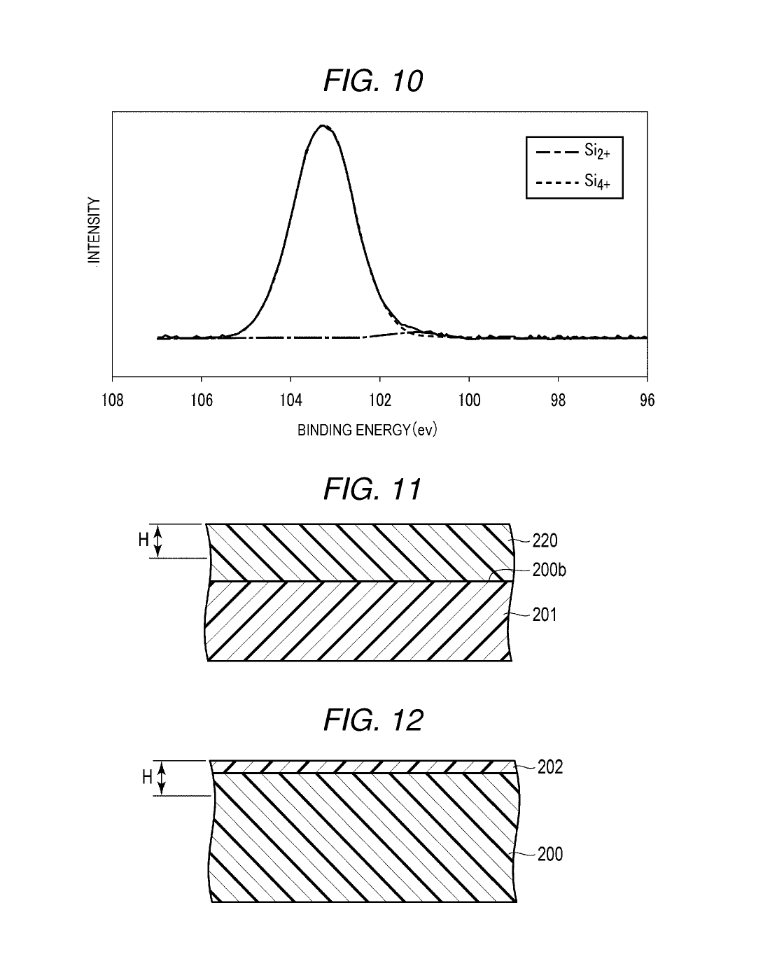

The film thickness of the oxygen silicon film used here is 4 μm as described above. This is substantially larger than the depth H (generally 10 nm or less) required by the XPS measurement as shown in FIG. 11. Therefore, according to this measurement, a Si2p spectrum showing a binding state of silicon and oxygen contained in a surface region of the silicon oxide film is considered to be obtained. These results are shown in FIGS. 9 and 10.

FIG. 9 is a graph showing the Si2p spectrum obtained by performing XPS measurement for the silicon wafer having a silicon oxide film. FIG. 10 is a graph showing the Si2p spectrum obtained by performing XPS measurement after performing oxygen plasma ashing on the silicon wafer having the silicon oxide film.

As shown in FIG. 9, in the Si2p spectrum when the oxygen plasma ashing time was 0 min, only a peak of silicon (Si₄₊), which is in a tetravalent binding state, was detected. On the other hand, as shown in FIG. 10, in the Si2p spectrum when the oxygen plasma ashing time was 5 min, a peak of silicon (Si₂₊), which is in a divalent binding state, was detected in addition to a peak of Si₄₊.

The above results revealed that when oxygen plasma ashing is performed for 3 min or more, the wettability of the silicon oxide film to an aqueous solution is improved, and as a result, the drug solution ejecting device 2 can eject the aqueous solution.

Then, as apparent from the results of the Si2p spectrum after performing oxygen plasma ashing for 5 min, this improved was considered to be derived from the formation of a dangling bond in a silicon atom by cleaving a bond of silicon and oxygen at surface region of the silicon oxide film through oxygen plasma ashing. Incidentally, as for the results of the XPS measurement obtained when performing oxygen plasma ashing, only the results for the case where oxygen plasma ashing was performed for 5 min are shown in FIG. 10, however, a similar Si2P spectrum to the experimental results shown in FIG. 10 was obtained when performing oxygen plasma ashing for 3 min or more.

Further, when the oxygen plasma ashing time was 2 min the contact angle was decreased as compared with the case where the oxygen plasma ashing time was 0 min, however, the drug solution ejecting device 2 could still not eject the aqueous solution. This is considered to be because the oxygen plasma ashing for 2 min was insufficient for cleaving bonds of silicon and oxygen present in the surface layer of the silicon wafer. That is, the results suggest that the oxygen plasma ashing for 2 min merely removes an organic substance adhered to the surface of the silicon wafer, and does not have substantial of an effect on bonding of silicon and oxygen present at the surface of the silicon wafer.

Subsequently, a silicon wafer having a natural oxide film formed thereon was subjected to oxygen plasma ashing for 0 min or 5 min under the same conditions as those for the oxygen plasma ashing performed when obtaining the data of FIG. 8. Thereafter, a binding state of silicon and oxygen contained in each natural oxide film subjected to oxygen plasma ashing for 0 min or 5 min was examined by XPS analysis. Incidentally, the film thickness of the natural oxide film formed on the surface of the silicon wafer, for example, the pressure chamber inner film 202 formed on the inner wall of the pressure chamber 210 among the surface of the pressure chamber structure 200 shown in FIG. 12 is 3 nm or less. The film thickness of the natural oxide film is smaller than the depth H (generally 10 nm or less) enabling XPS measurement as shown in FIG. 12. Therefore, according to this measurement, a Si2p spectrum showing a binding state of silicon and oxygen in three regions: the natural oxide film as the pressure chamber inner film 202, the silicon wafer 201, and the interface between the natural oxide film and the silicon wafer 201 is obtained.

That is, the silicon wafer having the natural oxide film formed thereon contains tetravalent silicon (Si₄₊), which is a binding state of silicon in the natural oxide film, zerovalent silicon (Si₀), which is a binding state of bulk silicon in the silicon wafer 201, and at least one of monovalent silicon (Si₁₊), divalent silicon (Si₂₊), and trivalent silicon (Si₃₊), which are binding states of sub-oxide silicon having a dangling bond and present at the interface. Therefore, in a Si2P spectrum obtained by performing XPS measurement for the silicon wafer having the natural oxide film formed thereon, three or more peaks are observed.

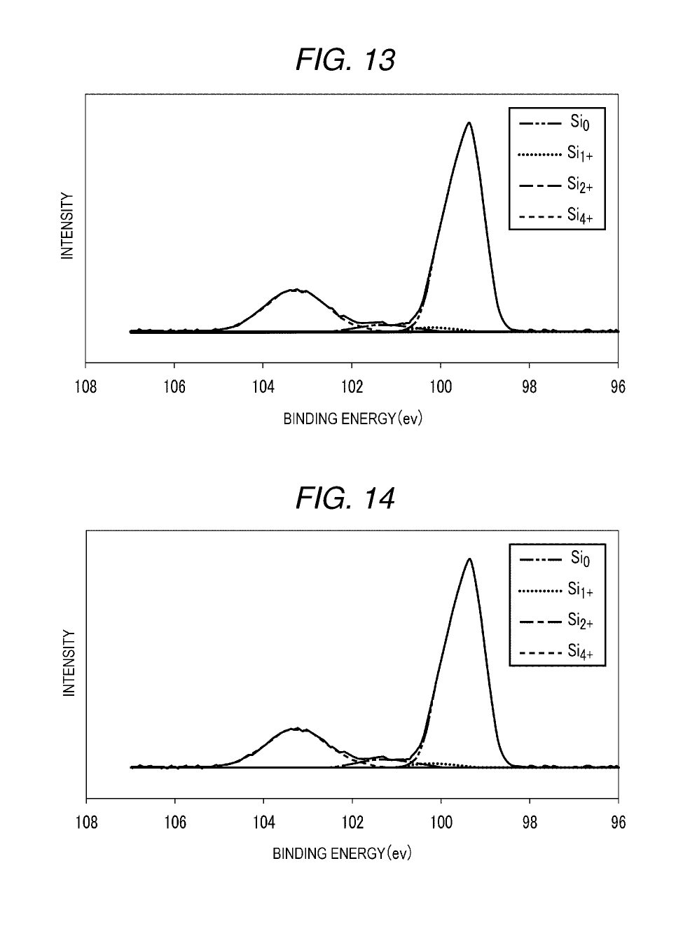

The measurement results are shown in FIGS. 13 and 14 and Table 2. FIG. 13 is a graph showing the Si2p spectrum obtained by performing XPS measurement on the silicon wafer having the natural oxide film formed thereon. FIG. 14 is a graph showing the Si2p spectrum obtained by performing XPS measurement after performing oxygen plasma ashing on the silicon wafer having the natural oxide film formed thereon. Table 2 shows the ratio of the area of each peak type to the total area of the peaks for zerovalent, monovalent, divalent, trivalent, and tetravalent silicon.

As shown in FIGS. 13 and 14, a total of 4 peaks is observed, one peak for each of tetravalent silicon (Si₄₊), zerovalent silicon (Si₀), monovalent silicon (Si₁₊), and divalent silicon (Si₂₊), in each of the Si2P spectra when the oxygen plasma ashing time was 0 min and when the oxygen plasma ashing time was 5 min.

TABLE 2

| Oxygen plasma | | | | | |
|---|---|---|---|---|---|
| ashing time | Si₀ | Si₁₊ | Si₂₊ | Si₃₊ | Si₄₊ |
| 0 min | 72.2% | 1.1% | 3.6% | 0% | 23.1% |
| 5 min | 72.2% | 1.1% | 4.6% | 0% | 22.1% |

As apparent from the results shown in FIGS. 13 and 14 and Table 2, in the Si2P spectrum when the oxygen plasma ashing time was 5 min, the peak intensity of divalent silicon (Si₂₊) increased as compared with that in the Si2P spectrum when the oxygen plasma ashing time was 0 min.

This indicates that by the oxygen plasma ashing, a bond of silicon and oxygen contained in the surface region of the natural oxide film (and thus also pressure chamber inner film 202) is cleaved, and a dangling bond is formed in a silicon atom.

Incidentally, as for the results of the XPS measurement obtained after performing oxygen plasma ashing, only the results for the case where oxygen plasma ashing was performed for 5 min are shown in FIG. 14, however, a similar Si2P spectrum to the experimental results shown in FIG. 14 is obtained when the oxygen plasma ashing time is 3 min or more.

Further, the measurement shown in FIGS. 13 and 14 and Table 2 was performed for a silicon wafer, however, similar results would be expected to be obtained when the measurement is performed on an assembly. That is, when oxygen plasma ashing is performed for 3 min or more for a natural oxide film formed on the inner wall of the pressure chamber 210, a dangling bond would be formed for silicon at the surface of the part composed of silicon or silicon oxide of the inner wall of the pressure chamber 210. Accordingly, the wettability of the inner wall of the pressure chamber 210 to an aqueous solution is improved, and therefore, the pressure chamber 210 is filled with the aqueous solution and a meniscus is formed in the nozzle 110. Due to this, a change in the volume of the pressure chamber 210 causes a change in the pressure of the drug solution in the pressure chamber 210. Therefore, the drug solution ejecting device 2 can eject the aqueous solution. On the other hand, when the wettability of the inner wall of the pressure chamber 210 to the aqueous solution is low, the aqueous solution does not necessarily reach the nozzle 110. Therefore, a gas-fluid interface of the aqueous solution is formed in the pressure chamber 210 and an air layer is formed in the pressure chamber 210. In this case, a change in the volume of the pressure chamber 210 by the deformation of the vibration plate 120 in the thickness direction might only cause a change in the volume of the air layer and does not cause a change in the pressure on the drug solution in the pressure chamber 210. Because of this, the drug solution ejecting device 2 is would not be able to eject the aqueous solution.

In this embodiment, oxygen plasma asking is described as a treatment method for improving the hydrophilicity of a surface coming into contact with a drug solution, however, irradiation with ultraviolet light at a wavelength of 300 nm or less may also be adopted as a treatment method for improving the hydrophilicity of a surface. Irradiation with ultraviolet light is sometimes performed for the purpose of cleaning the surface of a silicon wafer. However, the length of time of such irradiation is relatively short as compared to a length of time of irradiation for the purpose of obtaining a drug solution ejecting device according to this embodiment. That is, if the drug solution ejecting device according to this embodiment is attempted to be obtained by irradiation with ultraviolet light, irradiation is required to be performed for a sufficiently long time for cleaving a bond of silicon and oxygen as described below.

When irradiation with ultraviolet light is performed for the purpose of cleaning, irradiation with ultraviolet light is performed under such conditions that organic substances adhered to the surface of a silicon wafer are removed. For example, cleaning is performed by irradiation with ultraviolet light at a wavelength of 300 nm for less than 1 min of exposure time. In general, by doing this, the organic substances present on the surface of the silicon wafer are reduced in amount to be less than the measurement limit of XPS measurement.

However, when similar irradiation with ultraviolet light is performed for a longer time, for example, for 1 min or more and less than 3 min, the amount of organic substance remaining on the surface of the silicon wafer can be less than the XPS measurement limit and also a bond of silicon and oxygen present in the surface layer of the silicon wafer is exposed. However, bonds of silicon and oxygen are not substantially cleaved, and a Si2P spectrum obtained by performing XPS measurement includes only a peak of Si₄₊.

Therefore, irradiation with ultraviolet light is performed for a longer time, for example, 3 min or more, bonds of silicon and oxygen in the surface layer of the silicon wafer are sufficiently cleaved for detection. Therefore, a Si2P spectrum obtained by performing XPS measurement after 3 mins or more with ultraviolet light includes peaks of silicon in monovalent, divalent, and trivalent binding states.

While several embodiments of the invention have been described, these embodiments are presented by way of example only and are not intended to limit the scope of the invention. The novel embodiments described herein can be embodied in various other forms, and various omissions, substitutions, and changes can be made without departing from the gist of the invention. The embodiments and modifications thereof are included in the scope and gist of the invention and also included in the invention described in the claims and in the scope of their equivalents.

What is claimed is:

1. A drug solution ejecting device, comprising: a pressure chamber including a discharge port on a first side, a supply port on a second side, and an inner wall of the pressure chamber between the first and second sides; and
an actuator configured to change pressure in the pressure chamber to eject a solution in the pressure chamber from a nozzle via the discharge port, wherein
the inner wall of the pressure chamber includes at least a part that is silicon or silicon oxide, a surface of the part having a ratio of a total area of peaks of silicon in monovalent, divalent, and trivalent binding states, as detected by X-ray photoelectron spectroscopy, to an area of a peak of silicon in a tetravalent binding state, as detected by X-ray photoelectron spectroscopy, that is greater than such a ratio of a surface of a silicon wafer having only an untreated natural oxide film formed thereon.

2. The device according to claim 1, wherein at least a part of an inner wall of the nozzle is silicon or silicon oxide, and the part of the inner wall of the nozzle includes silicon in at least one of a monovalent, divalent, or trivalent binding state.

3. The device according to claim 2, wherein at least a part of the second face of the pressure chamber is silicon or silicon oxide, and the part of the second face includes silicon in at least one of a monovalent, divalent, or trivalent binding state.

4. The device according to claim 1, wherein at least a part of the second face of the pressure chamber is silicon or silicon oxide, and the part of the second face includes silicon in at least one of a monovalent, divalent, or trivalent binding state.

5. The device according to claim 1, wherein the solution is an aqueous solution.

6. The device according to claim 1, wherein the solution is a drug solution.

7. The device according to claim 1, wherein the inner wall of the pressure chamber is tapered toward the first face from the second face.

8. The device according to claim 1, the nozzle and the actuator are integrated with each other in a nozzle member disposed on a first side of the pressure chamber.

9. The device according to claim 1, wherein the pressure chamber is formed by etching into a silicon wafer from the second side towards the first side such that the inner wall of the pressure chamber is formed by an initially interior portion of the silicon wafer exposed by the etching.

10. The device according to claim 9, wherein the inner wall of the pressure chamber is exposed to an oxygen plasma for at least 3 minutes.

11. The device according to claim 9, wherein the inner wall of the pressure chamber is exposed to ultraviolet light at a wavelength of 300 nm or below for at least 3 minutes.

12. A drug solution dispensing device, comprising:
a drug solution ejecting device including:
a pressure chamber including a discharge port on a first side, a supply port on a second side, and an inner wall of the pressure chamber between the first and second sides; and
an actuator configured to change pressure in the pressure chamber to eject a solution in the pressure chamber from a nozzle via the discharge port; and
a mounting portion on which the drug solution ejecting device is mounted, wherein
the inner wall of the pressure chamber includes at least a part that is silicon or silicon oxide, a surface of the part having a ratio of a total area of peaks of silicon in monovalent, divalent, and trivalent binding states, as detected by X-ray photoelectron spectroscopy, to an area of a peak of silicon in a tetravalent binding state, as detected by X-ray photoelectron spectroscopy, that is greater than such a ratio of a surface of a silicon wafer having only an untreated natural oxide film formed thereon.

13. The drug solution dispensing device according to claim 12, wherein at least apart of an inner wall of the nozzle is silicon or silicon oxide, and the part of the inner wall of the nozzle includes silicon in at least one of a monovalent, divalent, or trivalent binding state.

14. The drug solution dispensing device according to claim 13, wherein at least a part of the second face of the pressure chamber is silicon or silicon oxide, and the part of the second face includes silicon in at least one of a monovalent, divalent, or trivalent binding state.

15. The drug solution dispensing device according to claim 12, wherein at least a part of the second face of the pressure chamber is silicon or silicon oxide, and the part of the second face includes silicon in at least one of a monovalent, divalent, or trivalent binding state.

16. The drug solution dispensing device according to claim 12, wherein the solution is an aqueous solution.

17. The drug solution dispensing device according to claim 12, wherein the solution is a drug solution.

18. The drug solution dispensing device according to claim 12, wherein the inner wall of the pressure chamber is tapered toward the first face from the second face.

19. A method of manufacturing a drug solution ejecting device, comprising:
forming a pressure chamber structure including a pressure chamber by etching a silicon wafer, the pressure chamber including a discharge port on a first side, a supply port on a second side, and an inner wall between the first and second sides;
forming an actuator configured to change pressure in the pressure chamber to eject a solution in the pressure chamber from a nozzle connected to the pressure chamber via the discharge port; and
treating the inner wall of the pressure chamber such that at least a part of the inner wall that is silicon or silicon oxide has a surface having a ratio of a total area of peaks of silicon in monovalent, divalent, and trivalent binding states, as detected by X-ray photoelectron spectroscopy, to an area of a peak of silicon in a tetravalent binding state, as detected by X-ray photoelectron spectroscopy, that is greater than such a ratio of a surface of a silicon wafer having only an untreated natural oxide film formed thereon.

20. The method of claim 19, wherein treating the inner wall of the pressure chamber comprises exposing the inner wall to at least one of an oxygen plasma or ultraviolet irradiation for three or more minutes.
